(19) United States
(12) Patent Application Publication
(10) Pub. No.: US 2016/0292788 A1
(43) Pub. Date: Oct. 6, 2016

(54) Currency and Financial Instrument Based Digital Assets

(71) Applicant: Domenick Gabriel Grasso, Pensacola, FL (US)

(72) Inventor: Domenick Gabriel Grasso, Pensacola, FL (US)

(21) Appl. No.: 14/673,696

(22) Filed: Mar. 30, 2015

(51) Int. Cl. G06Q 40/06

(52) U.S. Cl. CPC G06Q 40/06

(57) ABSTRACT

This invention is the creation of a novel class of digital assets, currency and financial instrument backed digital assets. This digital asset is backed by currency or other financial instrument to achieve a stable and fixed value and is programmable and uniquely identifiable. This digital asset can be used as a store of value and as a medium of exchange for commerce.

### CROSS-REFERENCE TO RELATED APPLICATIONS

Provisional Patent Application No. 61/975,155 “Currency and Financial Instrument Backed Digital Assets”

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

The basis of this invention was disclosed in a startup competition, Startup Weekend in Pensacola, Fla., on Mar. 30, 2014. On Apr. 4, 2014 a provisional patent was filed to protect the intellectual property of this invention.

### BACKGROUND OF THE INVENTION

1. Field of the Invention

This invention relates to the creation of a digital accounting asset (herein referred to as a digital asset) where its value is backed by a non-speculative financial instrument such as currency or a fixed-price financial product. The non-speculative nature of this digital asset provides a reliable, safe, and secure means of commence both electronically and physically. This digital asset is also programmable and uniquely identifiable. This invention is in stark contrast to digital currencies such as BitCoin which are speculative and are not backed by a source of fixed value.

2. Description of Related Art

Most prior art in this field consists of speculative digital currencies, minting processes for digital currencies, and the means to transfer digital currencies electronically. The most relevant prior art was the disclosure by the United States Internal Revenue Service on Mar. 25, 2014, that stated that digital currencies (such as BitCoin) should be considered according to generally accepted accounting principles and their gain or loss in value should be reflected in considering one's taxable income.

The current state of digital currency is dominated by BitCoin whereby solving an algorithm one receives a coin or fraction thereof and transactions are recorded in a database called a block chain. The value of these types of digital currencies varies wildly and is based on speculation and economic principles of supply and demand. Other digital currencies backed by gold have also been proposed but gold's value is speculative and therefore the digital currency's value varies.

The minting of digital currencies is also referenced in prior art. This process is analogous to the minting of physical currency and protection against counterfeiters is achieved by using secure cryptographic algorithms and electronic systems of exchange.

There are many references to the transfer of digital currencies in the prior art. These systems, like the minting procedure previously described, detail the communication between computer systems and utilize various communication and security protocols.

### BRIEF SUMMARY OF THE INVENTION

This invention is the creation of a novel class of digital assets, currency and financial instrument backed digital assets that are programmable and uniquely identifiable. These digital assets are backed by currencies or financial instruments to achieve a stable and fixed value. These digital assets avoid the speculative issues of digital currencies and provide a reliable, safe, and secure method to store and transfer value. There is no prior art that describes the creation and use of a digital asset that is backed by currency or financial instrument to achieve a stable and fixed value of exchange. There are many speculative digital currencies that do not have a fixed price and are subject to speculation and rapid changes in value.

### BRIEF DESCRIPTION OF THE SEVERAL VIEWS OF THE DRAWINGS

The features and advantages of the present invention will become fully appreciated and better understood when considered in conjunction with the accompanying drawings wherein:

FIG. 1 shows the analogous relationship between currency and the digital asset.

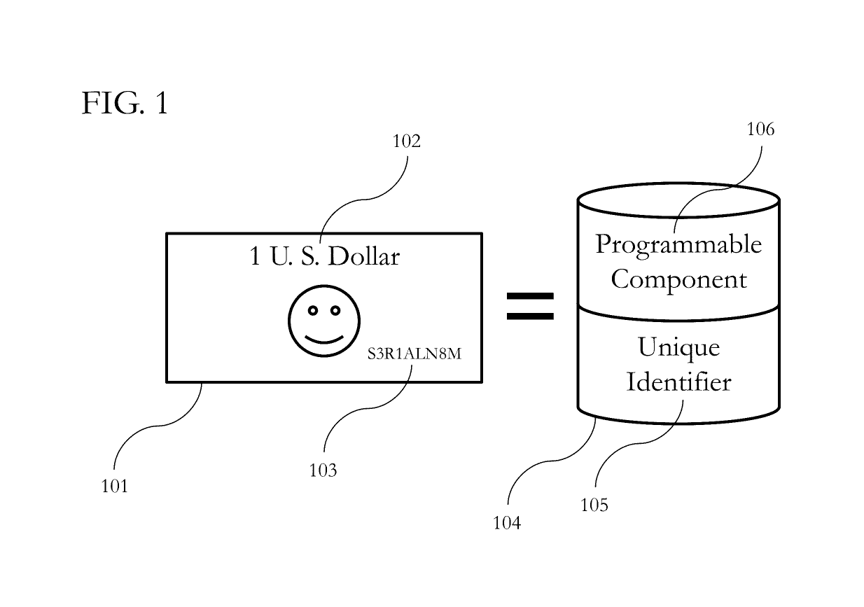

FIG. 2 shows the potential methods of transfer of these digital assets between parties.

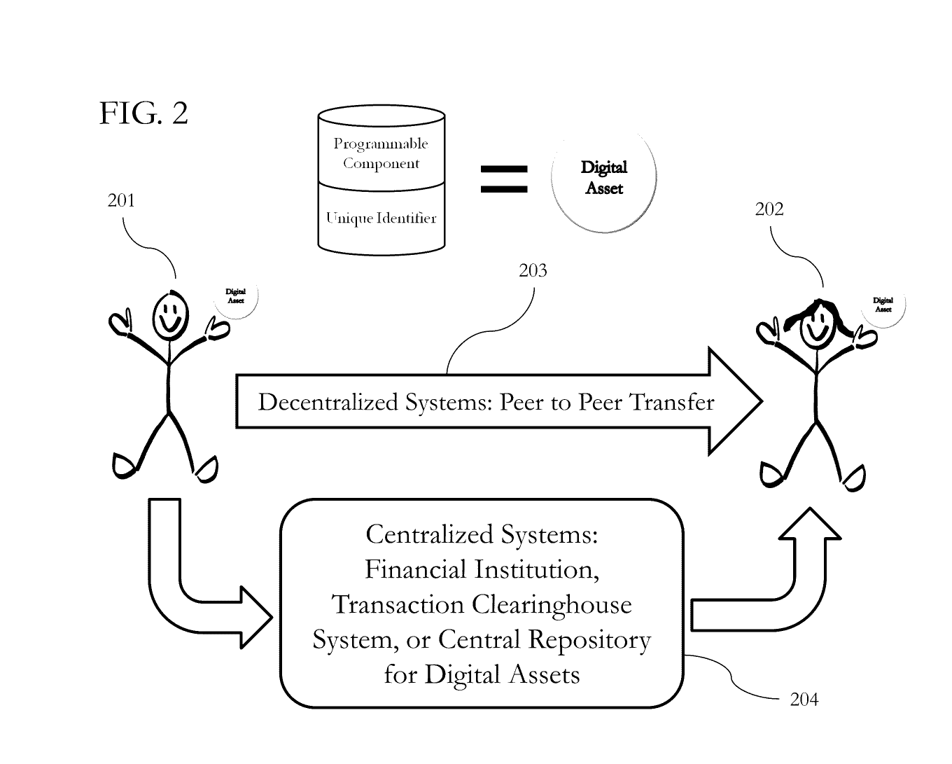

FIG. 3 shows the potential embodiments for the storage and use of digital assets.

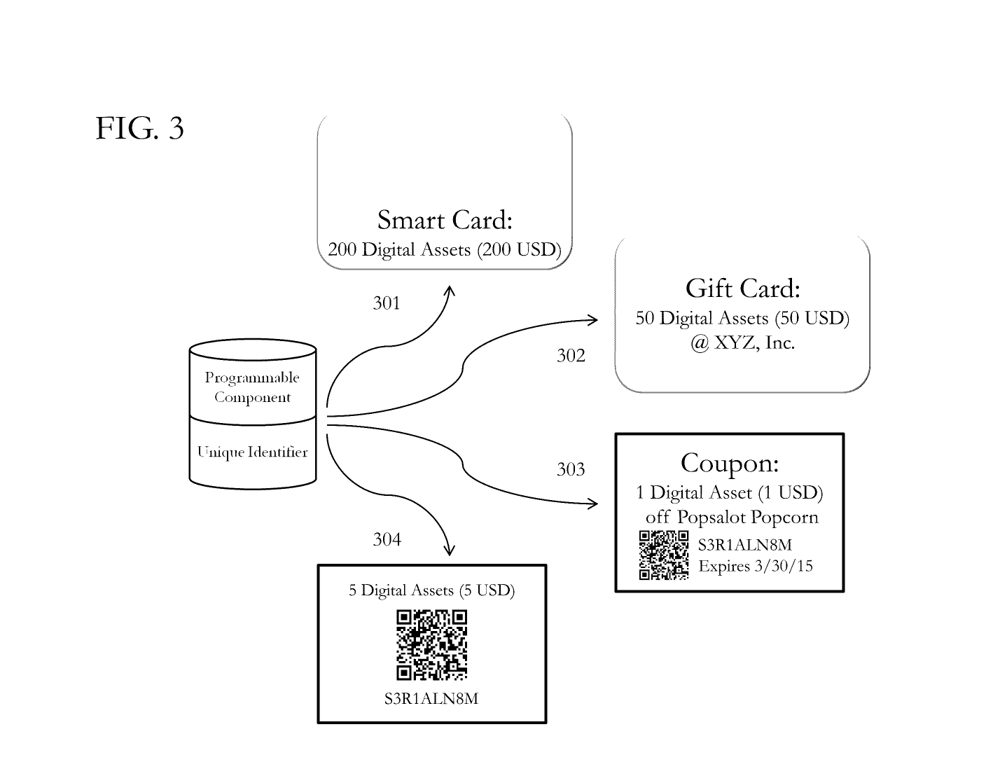

### DETAILED DESCRIPTION OF THE INVENTION

This invention is the creation of a novel class of digital assets, currency and financial instrument backed digital assets 104. This digital asset is backed by currency or financial instrument to achieve a stable and fixed value. An analogy of this digital asset would be a gold-standard U.S. dollar 101 that existed prior to 1973. The dollar's value was based on a unit of gold. This digital asset will be backed by a fixed ratio (e.g., 1:1 or other denomination) 102 to a currency or financial instrument. By backing this digital asset to a currency or financial instrument its value will be set at a fixed-price and will not be subject to speculation or changes in value. Being stable and non-speculative, this digital asset can be used as a reliable, safe, and secure medium to store or exchange value for commerce.

Each digital asset is programmable 106. As a technological invention, this digital asset will have properties that allow its programming functions to be executed based on time, location, and other various conditions. In the realm of commerce, this digital asset could assume the role of a store coupon 303, gift certificate 302, reward points, smart cards for electronic benefit transfers (EBT) 301, a means for remittances, or a myriad other uses that aids commerce. By acting as both a medium of exchange between consumer 201 and merchant, or recipient, 202 and being programmable, this digital asset will increase the efficiency and reduce the cost of these transactions.

Analogous to the serial number 103 on modern currency, each digital asset will have a unique identifier 105. This unique identifier is alphanumeric with optional symbols to prevent the digital asset from being copied, counterfeited, and stolen. In addition to its unique identifier, security measures can be used in conjunction with these digital assets including two-factor authentication and various cryptographic methods (e.g., key-pair et cetera).

The storage of these digital assets can be done locally electronically, on a smart card 301 or other electronic device such as a computer or smart device, or in a physical form 304, as an alphanumeric or image based code (e.g., QR or bar code). The storage of these digital assets can also be achieved via a centralized system 204 such as financial institutions or other types of exchange systems. The transfer of these digital assets can be accomplished using both centralized systems described above or decentralized 203 systems using peer to peer protocols or other communication systems between parties.

The following narratives provide illustrative examples of some preferred embodiments of this invention. These examples do not provide a comprehensive list of potential uses of this invention but do describe the spirit of these digital assets and their function in providing a reliable, safe, and secure method of commerce. Relevant security measures such as personal identification numbers (PINs) and other authentication methods are assumed in these examples:
1. As a medium of exchange this digital asset can be used as a 1:1 substitute for cash currency. John doesn't want to carry cash so he buys 100 digital assets for 100 USD and stores them electronically in a smart card 301 or by other electronic means (e.g., a smart device et cetera). He wants to buy shoes that cost 20 USD. At the teller, John exchanges 20 digital assets (that have a 1:1 value with the USD) with the merchant and leaves with his shoes and a balance of 80 digital assets. The merchant now has an additional 20 digital assets which can be redeemed for currency or used to purchase other goods.
2. As a programmable digital asset, a coupon 303, at a grocery store. John walks past a grocery store with his shoes and remembers, or is notified, that there is a promotion for 1 digital asset off popcorn that is valid for the next 2 days. The digital asset is programmed to expire and can only be used for a particular product. John enters the store and purchases the popcorn that is on sale for 3 USD but is discounted by 1 digital asset (1 USD) and completes the transaction with 2 digital assets. After buying shoes and the popcorn, John now has 78 digital assets.
3. As a programmable digital asset, a gift card 302, at a local merchant XYZ. This digital asset is now programmed to be used only at the merchant location and does not expire. Mary already has 200 digital assets on her smart card or other electronic device and receives a gift card in the form of 50 digital assets that can only be used at merchant XYZ. She now has 250 digital assets total but 50 of those can only be used at merchant XYZ. Mary walks to merchant XYZ and purchases a thank you card for 2 digital assets. Mary now has 248 digital assets total, 200 digital assets that are unrestricted and 48 digital assets that can only be used at merchant XYZ.
4. As a programmable digital asset, an electronic benefit transfer (EBT), at a grocery store. This digital asset is programmed to be used at any approved merchant but only to purchase milk, eggs, cheese, and bread. An attempt to purchase soda reports an error and insufficient digital assets.
5. As a programmable digital asset, money from a parent for a teenager to go to the movies. This digital asset is programmed to be used only at ABC theater for a total of 20 digital assets (20 USD) on that night. The programmed digital asset could be given to the teenager electronically or physically as a printed alphanumeric or image-based code. Plans change and the teenager decides to go dancing. The digital asset goes unused and expires. Its value is automatically transfers back to the parent. In theory this digital asset could be reprogrammed by the parent for the teenager to use to go dancing.
6. As a cash substitute 304, Jack owes Mary 10 USD. Instead of simply transferring the digital assets electronically Jack gives Mary an alphanumeric code of a digital asset transcribed on a physical object (e.g., a piece of paper). The digital asset is programmed to expire in 10 days and transfer to the recipient 10 digital assets (10 USD) from Jack's account 203. When Mary claims the code a day later 10 digital assets are transferred from Jack's to Mary's account. In this scenario, Mary could have given the code to anyone who could redeem those digital assets within 10 days.

I claim:

1. This invention describes the utility and function of a digital accounting asset (herein referred to as a digital asset) where:
a. the digital asset is backed by currency or financial instrument to achieve a fixed value; and
b. the fixed value digital asset is a store of value and redeemable in its respective currency.

2. The digital asset of claim 1 has a unique identifier of alphanumeric characters and/or symbols.

3. The digital asset of claim 1 is programmable as a function of time, location, value, and defined applicable uses and limitations.

4. The digital asset of claim 1 can be secured using authentication and cryptographic encryption protocols.

5. The digital asset of claim 1 can be stored locally and/or on a centralized system:
a. locally, the digital assets can be stored on electronic or other information based media or in a physical form using unique identifying alphanumeric characters and/or symbols transcribed or displayed on real and/or projected objects; and
b. on a centralized system, the digital assets can be stored on digital accounting ledgers and/or digital asset exchange systems.

6. The digital asset in claim 1 can be used as a means of commerce where:
a. in an electronic form, its value can be transmitted between two or more parties via the internet or other communication and information protocols; and
b. in a physical form, the digital asset can be transferred using a unique identifying alphanumeric characters and/or symbols or images transcribed or displayed on real and/or projected objects.
